(19) United States
(12) Patent Application Publication
(10) Pub. No.: US 2016/0325327 A1
(43) Pub. Date: Nov. 10, 2016

(54) LUBRICATION USING SPRAY NOZZLES HAVING MULTIPLE OIL INLET OPENINGS

(71) Applicant: PRIMETALS TECHNOLOGIES AUSTRIA GNBH, Linz (AT)

(72) Inventors: Martin BOEHM, Linz (AT); Thomas BRAIDT, Linz (AT); Gernot DIRISAMER, Tollet (AT); Konrad KRIMPELSTAETTER, Katsdor, Österreich (AT); Daniel VIPAVC, Linz (AT)

(21) Appl. No.: 15/109,067

(22) PCT Filed: Nov. 18, 2014
(86) PCT No.: PCT/EP2014/074844

§ 371 Date: Jun. 29, 2016

(30) Foreign Application Priority Data
Jan. 8, 2014 (EP) 14150400.1

(51) Int. Cl. B21B 45/02; B05B 7/08; B05B 13/02; B05B 7/04

(52) U.S. Cl. CPC B21B 45/0251; B05B 7/0483; B05B 7/0876; B05B 13/0278

(57) ABSTRACT

During the rolling of a metallic flat rolling stock (1) in a roll stand (2), lubricating oil (5) is sprayed onto the rolling stock (1) and/or at least one roll (3,4) of the roll stand (2) by multiple spray nozzles (7) arranged beside one another. In each case, a mixing chamber (8) of a spray nozzle (7) is fed with a respective quantity of lubricating oil (5) via respective multiple oil inlet openings (9). The respective mixing chamber (8) is fed with compressed air (11) via respectively one air inlet opening (10). Compressed air (11) atomizes the lubricating oil (5) in the respective mixing chamber (8) to form an aerosol and, via respectively at least one nozzle outlet (12), is sprayed onto the rolling stock (1) and/or the at least one roll (3,4) of the roll stand (2).

### CROSS-REFERENCE TO RELATED APPLICATIONS

The present application is a 35 U.S.C. §§371 national phase conversion of PCT/EP2014/074844, filed Nov. 18, 2014, which claims priority of European Patent Application No. 14150400.1, filed Jan. 8, 2014, the contents of which are incorporated by reference herein. The PCT International Application was published in the German language.

### BACKGROUND OF THE INVENTION

The present invention relates to a method for applying a lubricating oil to flat metal rolling stock and/or at least one roll of a roll stand during the rolling of the rolling stock in the roll stand by means of a plurality of spray nozzles arranged adjacent to one another.

In each case, a mixing chamber of a spray nozzle is fed with a respective quantity of lubricating oil via one oil inlet opening in each case.

The respective mixing chamber is fed with compressed air via at least one air inlet opening in each case.

The lubricating oil is atomized in the respective mixing chamber by means of the compressed air to form an aerosol and is sprayed onto the rolling stock and/or the at least one roll of the roll stand via at least one nozzle outlet of the respective spray nozzle in each case.

The present invention further relates to a device for applying a lubricating oil to flat metal rolling stock and/or at least one roll of a roll stand during the rolling of the rolling stock in the roll stand,
wherein the device has a spray bar which extends parallel to an axis of rotation of the at least one roll of the roll stand and a plurality of spray nozzles arranged adjacent to one another on the spray bar.

Each of the spray nozzles has a mixing chamber which is fed with a respective quantity of lubricating oil via one oil inlet opening in each case.

The respective mixing chamber has in each case at least one air inlet opening via which the respective mixing chamber is fed with compressed air.

Each of the spray nozzles has at least one nozzle outlet via which the lubricating oil atomized in the respective mixing chamber to form an aerosol is sprayed onto the rolling stock and/or the at least one roll of the roll stand.

A method and a device of this kind are known. Reference is made, purely by way of example, to US 2010/0 258 380 A1 or also to EP 2 465 619 A1.

The lubrication of the roll gap during cold rolling is extremely important for the stability and quality of the rolling process. Conventionally, an oil/water emulsion is used for lubricating the roll gap. More recently, however, it has also already become known to spray pure lubricating oil, for example in the form of base oil, onto the rolling stock and/or the at least one roll instead of an oil/water emulsion.

During the spraying operation, it is necessary to apply the lubricating oil evenly over the entire width that is to be lubricated. Viewed over the length of the rolling stock, however, the quantity of lubricating oil can vary. Depending on the rolling conditions, such as, for example, width of the rolling stock, rolling speed, reduction per pass, rolling force, etc., the quantity of lubricating oil applied to the rolling stock and/or the at least one roll in the case of a specific roll stand can vary between 35 ml/minute and 2000 ml/minute. Referred to an individual spray nozzle, the quantity of lubricating oil can vary between 2 ml/minute and 60 ml/minute. Referred to an individual spray nozzle, it is therefore necessary to apply the quantity of lubricating oil reliably to the rolling stock and/or the at least one roll over a wide range of adjustment (minimum-to-maximum ratio approx. 1:30).

A further problem is that the oil inlet openings may become blocked. If such a blockage occurs, a part of the rolling stock and/or of the roll gap will be lubricated only to an inadequate extent. This has significantly negative effects on the rolling process as a consequence.

### SUMMARY OF THE INVENTION

The object of the present invention is to provide possible ways by means of which the requisite range of adjustment can be guaranteed in a simple and reliable manner and in addition to avoid blockages as far as possible or at least to limit their effects.

According to the invention, a method of the type cited in the introduction is embodied in that in each case a mixing chamber of a spray nozzle is fed with the respective quantity of lubricating oil not only via a single oil inlet opening in each case, but via a plurality of oil inlet openings in each case.

This makes it possible for example to feed a respective sub-quantity of lubricating oil to each of the oil inlet openings independently of one another. Thus, for a relatively small quantity of lubricating oil, for example, that quantity can be supplied via just one or two of the oil inlet openings for a relatively large quantity of lubricating oil, that quantity of oil can be supplied via all or almost all of the oil inlet openings. Furthermore, blockages usually occur independently of one another. Even if a blockage of one of the oil inlet openings were to occur, the spray nozzle can continue to be fed with the lubricating oil via the remaining oil inlet openings. In an individual case, there is a possibility that in the event of blockage of one of the oil inlet openings, only a reduced range of adjustment will be realizable thereafter. However, a total failure of the oil supply can be avoided virtually with certainty.

Preferably, the spray nozzles are embodied as cylindrical, such that they have a respective longitudinal axis. In this case, the nozzle outlets are preferably arranged at one of the axial ends of the respective spray nozzle and the at least one air inlet opening in each case is arranged at the other axial end of the respective spray nozzle. This results in a simple configuration of the spray nozzles in constructional terms and a simple and stable guidance of the compressed air in the spray nozzle, in particular in the mixing chamber.

Referred to one of the spray nozzles in each case, one of the oil inlet openings is arranged at a defined axial position, viewed in the direction of the longitudinal axis. Preferably, at least one other of the oil inlet openings is arranged at the same axial position, viewed in the direction of the longitudinal axis. This enables the axial position for the oil inlet openings to be determined in a consistently optimal manner.

Preferably, the oil inlet openings arranged at the defined axial position are arranged evenly distributed, viewed around the longitudinal axis. This enables a particularly good atomization of the lubricating oil to be achieved.

Preferably, the lubricating oil is fed to the respective mixing chamber in a flow-controlled manner. This enables the quantity of lubricating oil to be dispensed particularly efficiently.

In practice it has proved advantageous if the compressed air fed to the respective mixing chamber has a pressure that lies between 0.1 bar and 10 bar. The pressure can lie in particular between 1.0 bar and 6.0 bar.

Preferably, a pressure at which the compressed air is fed to the respective mixing chamber is set as a function of the quantity of lubricating oil fed to the respective mixing chamber. This enables the formation of the aerosol by a selected pressure of the compressed air to be optimized. In particular, the pressure at which the compressed air is fed to the respective mixing chamber can increase in line with the quantity of lubricating oil fed to the respective mixing chamber.

In practice it had furthermore proved advantageous if the at least one air inlet opening has a diameter that lies between 0.01 mm and 5 mm. Preferably, the diameter can lie between 3 mm and 5 mm, in particular around at least 4 mm.

In practice it has furthermore proved advantageous if the oil inlet openings have a diameter that lies between 0.1 mm and 1.0 mm. The diameter can lie in particular between 0.4 mm and 0.6 mm.

Preferably, each of the nozzle outlets is embodied as slit-shaped. This enables in particular a relatively wide fan-like jet to be produced.

In practice it has furthermore proved advantageous if the nozzle outlets are spaced apart from the rolling stock and/or the working roll onto which the lubricating oil is sprayed at a distance that lies between 100 mm and 400 mm. The distance can lie in particular between 150 mm and 300 mm.

In practice it has furthermore proved advantageous if the spray nozzles are spaced apart from one another by a distance that lies between 50 mm and 300 mm. The distance can lie in particular between 100 mm and 200 mm.

The lubricating oil sprayed onto the rolling stock and/or the at least one roll by one of the spray nozzles in each case is sprayed onto a respective subarea of the rolling stock and/or of the at least one roll. Preferably, the subareas assigned to immediately adjacent spray nozzles have a degree of overlap that lies between 0% and 50%. At a degree of overlap of 0%, the subareas only adjoin one another, without overlapping. At a degree of overlap of 50%, the center of one subarea lies at the border of the other subarea, and vice versa.

According to the invention, the device, analogously to the method, is embodied in that in each case a mixing chamber of a spray nozzle is fed with the respective quantity of lubricating oil not just via a single oil inlet opening in each case, but via a plurality of oil inlet openings in each case.

The advantageous embodiments of the device correspond to those of the method. In the interest of avoiding repetitions, reference is therefore made to the foregoing statements in relation to the method.

The above-described characteristics, features and advantages of this invention, as well as the manner in which these are achieved, will become clearer and more readily understandable taken in conjunction with the following description of the exemplary embodiments, which are explained in more detail with reference to the schematic drawings, in which:

### BRIEF DESCRIPTION OF THE DRAWINGS

FIG. 1 schematically shows a roll stand and a flat rolling stock from the side,

FIG. 2 schematically shows the roll stand and the rolling stock of FIG. 1 from above,

FIG. 3 shows a spray nozzle in a sectional view,

FIG. 4 shows a cross-section through the spray nozzle of FIG. 3 along a line IV-IV of FIG. 3,

FIG. 5 shows a cross-section through a further spray nozzle corresponding to the view of FIG. 4,

FIG. 6 shows a volume-pressure diagram,

FIG. 7 shows an embodiment variant of a nozzle outlet in a perspective view,

FIG. 8 shows an embodiment variant of a nozzle outlet in a sectional view, and

FIGS. 9 to 11 schematically shows an arrangement of a plurality of spray nozzles in each case.

### DESCRIPTION OF EMBODIMENTS

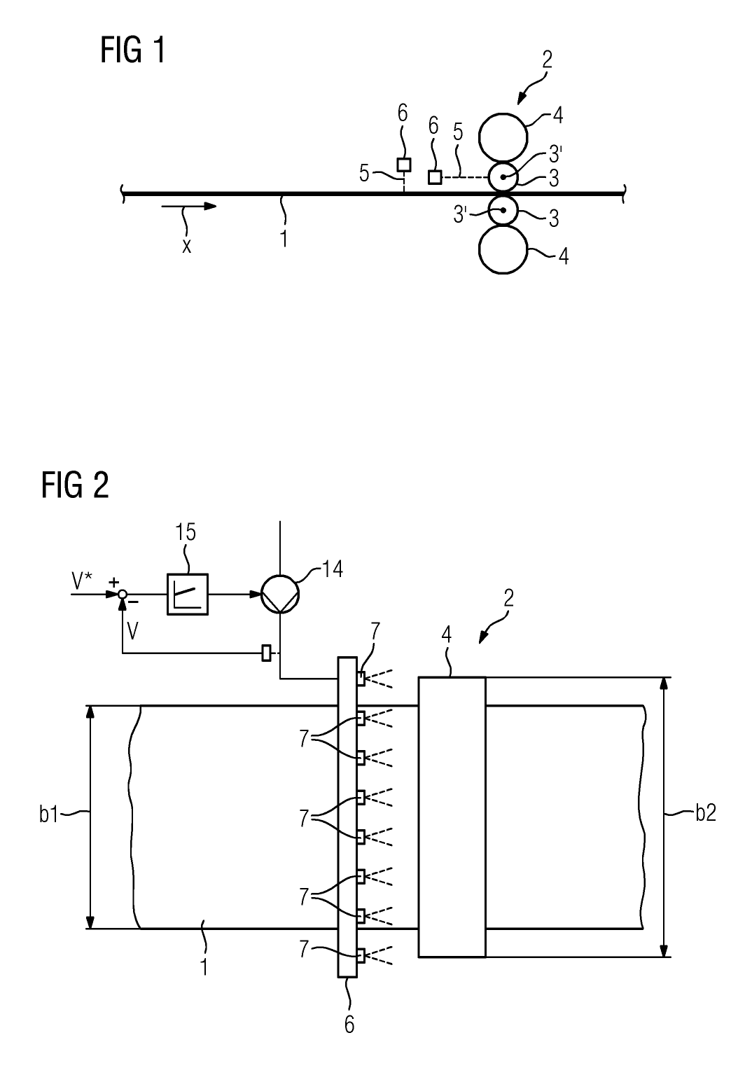

According to FIGS. 1 and 2, a flat metal rolling stock 1 is rolled in a roll stand 2. During the rolling process, the rolling stock 1 is conveyed in a transport direction x. The roll stand 2 has at least working rolls 3. Often the roll stand 2 additionally has backup rolls 4 and, where necessary also, further rolls not shown in the Figures.

When the rolling stock 1 is rolled in the roll stand 2, a lubricating oil 5 is applied to the rolling stock 1 and/or at least one of the rolls 3, 4 of the roll stand 2, as illustrated in FIGS. 1 and 2. According to the view shown in FIG. 1, lubricating oil 5 is applied to the top side of the rolling stock 1 and to the upper working roll 3. It is however sufficient, insofar as the top side of the rolling stock 1 is concerned, for lubricating oil 5 to be applied to the top side of the rolling stock 1 or to the upper working roll 3. It would furthermore be possible, alternatively or in addition to the application of the lubricating oil 5 to the top side of the rolling stock 1 and/or to the upper working roll 3, to apply lubricating oil 5 to another roll 4 arranged above the rolling stock 1, for example to the upper backup roll 4 or (in the case of a six-high stand) to the upper intermediate roll.

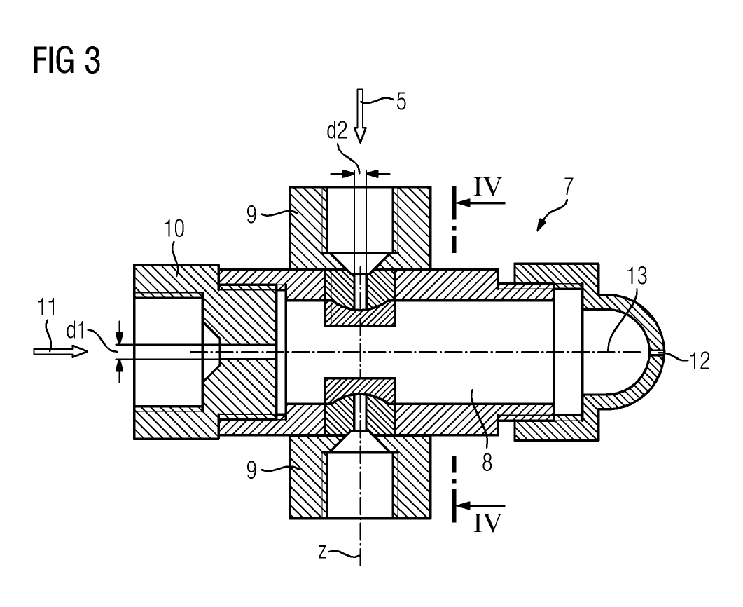

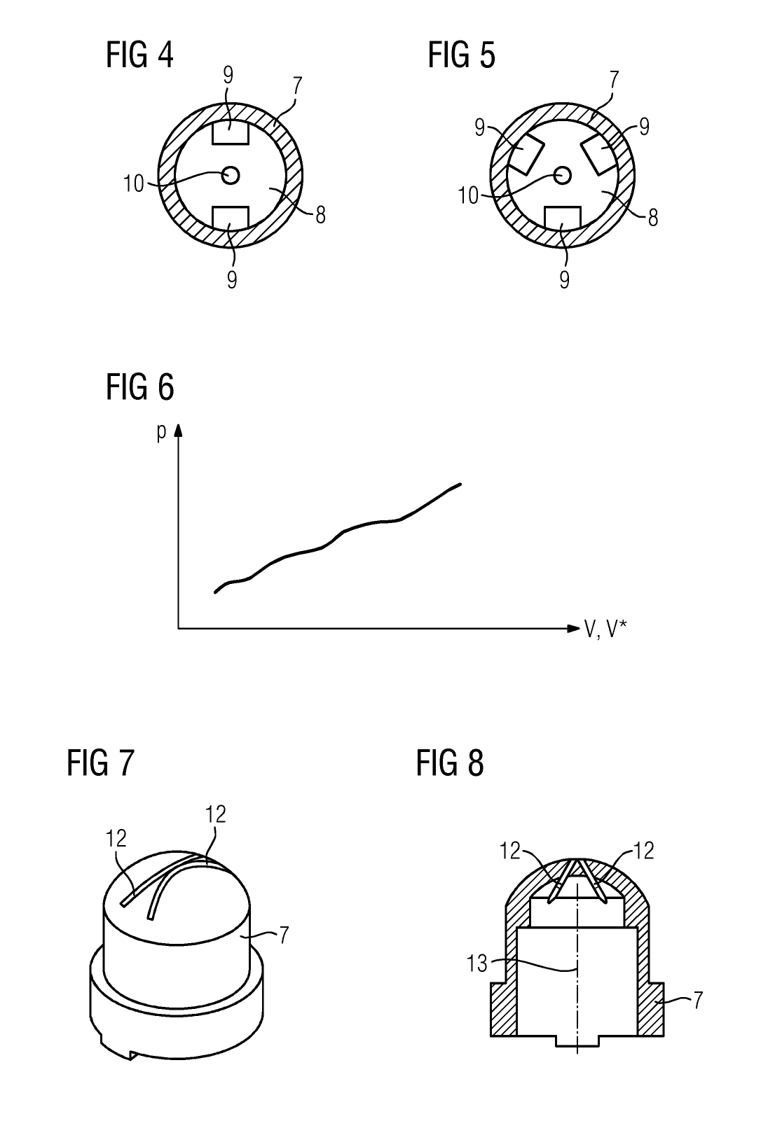

According to FIGS. 1 and 2, a device for applying the lubricating oil 5 to the top side of the rolling stock 1 and/or at least one roll 3, 4 arranged above the rolling stock 1 has a spray bar 6. The spray bar 6 extends parallel to a respective axis of rotation 3′ of the working rolls 3. A plurality of spray nozzles 7 are arranged adjacent to one another along the spray bar 6. Collectively, the spray nozzles 7 are usually identical in construction. The design of one of the spray nozzles 7 is explained in more detail in the following with reference to FIGS. 3 and 4.

Furthermore, lubricating oil 5 is usually applied also to the underside of the rolling stock 1 and/or to at least one lower roll 3, 4. This is not shown in FIGS. 1 and 2 simply for clarity of illustration reasons. In an analogous manner to the application of the lubricating oil 5 to the top side of the rolling stock 1 and/or to the upper working roll 3 and/or to another roll 4 arranged above the rolling stock 1, the lubricating oil 5 can also be applied in respect of the underside of the rolling stock 1 as necessary (directly) to the lower side of the rolling stock 1 and/or to the lower working roll 3 and/or to another roll 4 arranged below the rolling stock 1. Furthermore, at least one spray bar 6 is also arranged below the rolling stock 1 in this case.

According to FIG. 3, each of the spray nozzles 7 has a mixing chamber 8. Furthermore, each of the spray nozzles 7 has a plurality of oil inlet openings 9. A minimum of two oil inlet openings 9 are present. However, there may also be more than two oil inlet openings 9 present. A respective quantity V of lubricating oil 5 is fed via the oil inlet openings 9 to the respective mixing chamber 8 per unit time. Furthermore, the mixing chambers 8 have in each case at least one air inlet opening 10. Compressed air 11 is fed to the respective mixing chamber 8 via the respective air inlet opening 10. Inside the respective mixing chamber 8, the supplied lubricating oil 5 is atomized by means of the compressed air 11 to produce an aerosol. Selection of parameters of oil and the compressed air causes the oil to be atomized in the mixing chamber. These include qualities of the oil, air pressure, quantity of oil, etc. known to the art for atomizing. The atomized lubricating oil 5 is sprayed onto the rolling stock 1 and/or the corresponding roll 3, 4 of the roll stand 2 via in each case at least one nozzle outlet 12 of the respective spray nozzle 7.

Referring to FIG. 3, the spray nozzles 7 are preferably embodied as cylindrical. They accordingly have a respective longitudinal axis 13. The nozzle outlets 12 are preferably arranged at one of the axial ends of the respective spray nozzle 7. The respective at least one air inlet opening 10 is in this case arranged at the respective other axial end of the respective spray nozzle 7.

Referred to one of the spray nozzles 7 in each case, one of the oil inlet openings 9 is arranged at a defined axial position z, viewed in the direction of the longitudinal axis 13. At least one other of the oil inlet openings 9 is arranged preferably at the same axial position z, viewed in the direction of the longitudinal axis 13. Oftentimes, even all of the oil inlet openings 9 of the respective spray nozzle 7 are arranged at the axial position z.

Referring to FIG. 3, the at least one air inlet opening 10 preferably has a diameter d1 between 0.01 mm and 5 mm. Preferably, the diameter d1 of the air inlet openings 10 is between 3 mm and 5 mm. In particular, the diameter d1 of the air inlet openings 10 may be around at least 4 mm. The oil inlet openings 9 likewise have a diameter d2. The diameter d2 of the oil inlet openings 9 is preferably between 0.1 mm and 1.0 mm. In particular, the diameter d2 of the oil inlet openings 9 typically is between 0.4 mm and 0.6 mm.

In FIG. 4 for two oil inlet openings 9 and in FIG. 5 for three oil inlet openings 9, the oil inlet openings are preferably evenly distributed around the longitudinal axis 13. Referred to the longitudinal axis 13, the oil inlet openings 9 therefore preferably are at an angle of 180° apart for two oil inlet openings 9, and at an angle of 120° apart for three oil inlet openings 9. Generally, for n oil inlet openings 9, every two neighboring oil inlet openings 9 preferably form an angle of 360°/n around the longitudinal axis 13.

FIG. 2 shows an example for one of the spray nozzles 7. The lubricating oil 5 is fed to the respective mixing chamber 8 (FIG. 3) preferably in a flow-controlled manner. For this purpose, in FIG. 2, a conveying device 14 and a flow controller 15 are present. The flow controller 15 is supplied with a setpoint volume flow V* and an actual volume flow V delivered to the respective mixing chamber 8 by the conveying device 14. On the basis of the setpoint volume flow V* and the actual volume flow V, the flow controller 15 determines a control signal for the conveying device 14 in order that the actual volume flow V will be approximated to, and ideally aligned with, the setpoint volume flow V*. Owing to the conveying of the volume flow, pressure builds up in the supply line conducting the lubricating oil 5. This pressure is not controlled within the scope of the present invention. In most cases it settles between 1.5 bar and 20 bar and in particular between 2.0 bar and 15 bar.

A pressure p of the compressed air 11 fed to the respective mixing chamber 8 preferably is between 0.1 bar (=10 hPa) and 10 bar (=1000 hPa). In particular, the pressure p can be between 1.0 bar (=100 hPa) and 6.0 bar (=600 hPa). It is possible that the pressure p remains constant at the corresponding value. Preferably, however, the pressure p will be adjusted in accordance with the quantity of lubricating oil 5, i.e. as a function of one of the volume flows V, V*. FIG. 6 shows a corresponding graph to show an example. In FIG. 6, the quantity of lubricating oil 5 that is fed to the mixing chamber 8 per unit time is plotted to the right. The associated pressure p of the compressed air 11 is plotted vertically in FIG. 6. According to the graph shown in FIG. 6, it is possible in particular that the pressure p increases in line with the quantity of lubricating oil 5 that is fed to the respective mixing chamber 8 per unit time. Preferably, therefore, the following relation applies:

dp/dV>0

or

dp/dV*>0.

The nozzle outlets 12 can be fashioned as necessary. Preferably, the nozzle outlets 12 are in each case embodied as slit-shaped according to the illustration in FIGS. 7 and 8. In particular, the spray nozzles 7 can in each case have two nozzle outlets 12 of said type. A relatively wide, fan-like, uniform jet can be produced in a particularly simple manner by means of nozzle outlets 12 of this type.

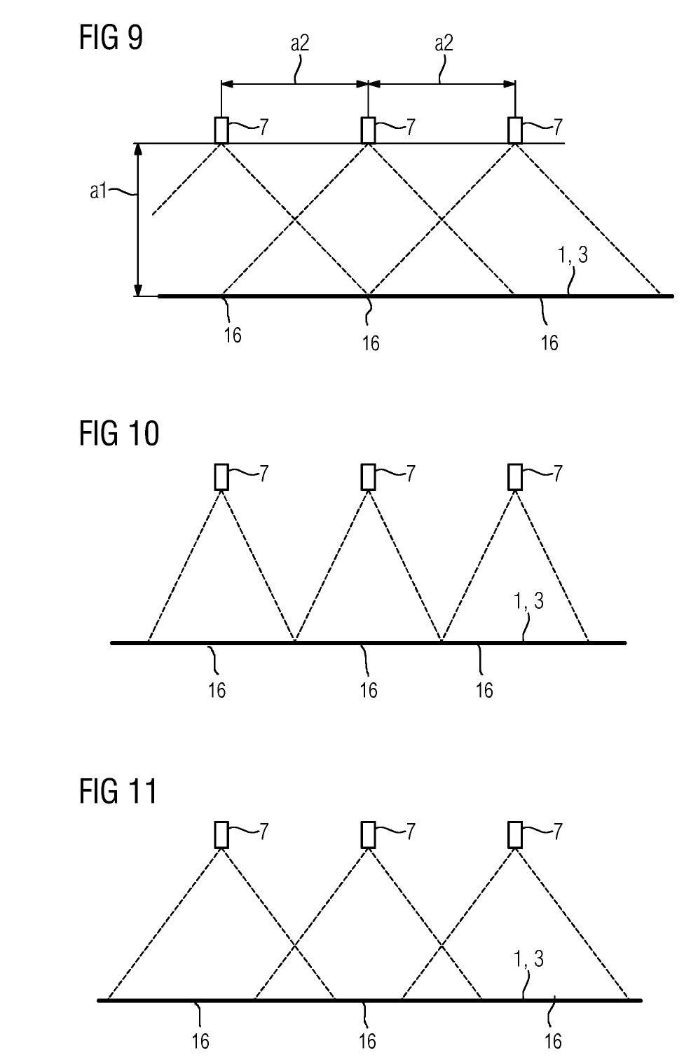

According to FIG. 9, the nozzle outlets 12 are spaced at a distance a1 from the surface onto which the lubricating oil 5 is sprayed. The surface can alternatively be a surface area of the rolling stock 1 or a surface of one of the rolls 3, 4. The distance a1 preferably is between 100 mm and 400 mm. In particular, it can lie between 150 mm and 300 mm. According to FIG. 9, the spray nozzles 7 are furthermore spaced apart from one another by a distance a2, which extends parallel to the axes of rotation 3′ of the working rolls 3. The distance a2 preferably between 50 mm and 300 mm. In particular, it is between 100 mm and 200 mm.

According to FIG. 9, the lubricating oil 5 is sprayed only onto a respective subarea 16 of the rolling stock 1 and/or the corresponding roll 3, 4 by one of the spray nozzles 7 in each case. By means of the spray bar 6, i.e. the spray nozzles 7 in their totality, in contrast, the lubricating oil 5 is applied evenly to the rolling stock 1 and/or the corresponding roll 3, 4 at least over the width b1 (FIG. 2) of the rolling stock 1—often even over the full width b2 of the corresponding roll 3, 4. In order to ensure such a uniform application, the distances a1 of the nozzle outlets 12 from the rolling stock 1 or, as the case may be, from the corresponding roll 3, 4 and the distances a2 (FIG. 9) of the spray nozzles 7 from one another are set as a function of the respective spray pattern of one of the spray nozzles 7 in each case.

Depending on the circumstances of the individual case, the distances can be set in such a way that the subareas 16 assigned to immediately adjacent spray nozzles 7 have a degree of overlap of 50%. In this case, as shown in FIG. 9, the subarea 16 of one spray nozzle 7 extends to the middle of the two subareas 16 immediately adjoining the subarea 16. Referring to a specific subarea 16, there therefore exist a left-hand section and a right-hand section. Lubricating oil 5 is applied to the right-hand section also by the adjacent spray nozzle 7 on the right. Lubricating oil 5 is applied to the left-hand section also by the adjacent spray nozzle 7 on the left. Therefore, there is no section of the subarea 16 to which lubricating oil 5 is applied exclusively by the spray nozzle 7 assigned to that subarea 16.

Alternatively, depending on the circumstances of the individual case, FIG. 10 shows that the distances can be set such that the subareas 16 assigned to immediately adjacent spray nozzles 7 have 0 degree overlap In FIG. 10, the subarea 16 of a specific spray nozzle 7 extends only up to the border of the two subareas 16 immediately adjoining the subarea 16. The subareas 16 adjoin one another without overlapping. There, therefore exists no section to which lubricating oil 5 is applied also by the adjacent spray nozzle 7 on the right or the left.

In most cases, however, the distances set are chosen in such a way that the subareas 16 assigned to immediately adjacent spray nozzles 7 have a degree of overlap that lies between the two extreme values, 0% to 50%. Referring to a specific subarea 16 in FIG. 11, there are a left-hand section and a right-hand section adjacent each other section. Lubricating oil 5 is applied to the right-hand section also by the adjacent spray nozzle 7 on the right. Lubricating oil 5 is applied to the left-hand section also by the adjacent spray nozzle 7 on the left. Between the two sections, there remains, in contrast to the embodiment of FIG. 9, a middle section of the subarea 16 to which lubricating oil 5 is applied exclusively by the respective associated spray nozzle 7. For example, the distances set can be chosen such that the subareas 16 assigned to immediately adjacent spray nozzles 7 have a degree of overlap between 15% and 40%, and in particular between 20% and 30%. FIG. 11 shows, for example, a setting of in which the degree of overlap is at approx. 25%.

To sum up, the present invention accordingly relates to the following state of affairs:

During the rolling of a flat metal rolling stock 1 in a roll stand 2, lubricating oil 5 is sprayed onto the rolling stock 1 and/or at least one roll 3, 4 of the roll stand 2 by a plurality of spray nozzles 7 arranged adjacent to one another.

In each case, a mixing chamber 8 of a spray nozzle 7 is fed with a respective quantity of lubricating oil 5 via a plurality of oil inlet openings 9. The respective mixing chamber 8 is also fed with compressed air 11 via at least one air inlet opening 10. The compressed air is at a sufficient pressure such that the lubricating oil 5 is atomized in the respective mixing chamber 8 by the compressed air 11 to form an aerosol and is then sprayed onto the rolling stock 1 and/or the at least one roll 3, 4 of the roll stand 2 via at least one nozzle outlet 12 in each case.

The present invention has numerous advantages. In particular, a wide range of adjustment of the conveyed volume flow V of lubricating oil 5 can be realized in a simple manner. Furthermore, the reliability of the spray nozzles 7 is significantly increased on account of the presence of a plurality of oil inlet openings 9. In addition, the spray pattern of the spray nozzles 7 which corresponds to the respective subarea 16, can be maintained virtually constant over the entire range of adjustment of the conveyed volume flow V. The total quantity of lubricating oil 5 required can be kept to a minimum. This is notwithstanding an oil film having a very uniform thickness produced over the entire effective width.

Although the invention has been illustrated and described in more detail on the basis of the preferred exemplary embodiment, the invention is not limited by the disclosed examples and other variations can be derived herefrom by the person skilled in the art without leaving the scope of protection of the invention.

### LIST OF REFERENCE SIGNS

1 Rolling stock
2 Roll stand
3 Working rolls
3′ Axes of rotation
4 Backup rolls
5 Lubricating oil
6 bar
7 Spray nozzles
8 Mixing chamber
9 Oil inlet openings
10 Air inlet opening
11 Compressed air
12 Nozzle outlets
13 Longitudinal axis
14 Conveying device
15 Flow controller
16 Subareas
a1, a2 Distances
b1, b2 Widths
d1, d2 Diameters
p Pressure
V, V* Volume flows
x Transport direction
z Axial position

1. A method for applying a lubricating oil (5) during rolling of a flat metal rolling stock (1) in a roll stand (2),
wherein the lubricating oil (5) is sprayed onto the rolling stock (1) and/or at least one roll (3, 4) of the roll stand (2) by means of a plurality of spray nozzles (7) arranged adjacent to one another,
wherein in each case a mixing chamber (8) of a spray nozzle (7) is fed with a respective quantity of lubricating oil (5) via a plurality of oil inlet openings (9) in each case,
wherein the respective mixing chamber (8) is fed with compressed air (11) via at least one air inlet opening (10) in each case,
wherein the lubricating oil (5) is atomized in the respective mixing chamber (8) by means of the compressed air (11) to form an aerosol and is sprayed onto the rolling stock (1) and/or the at least one roll (3, 4) of the roll stand (2) via at least one nozzle outlet (12) in each case.

2. The method as claimed in claim 1,
characterized in that
the spray nozzles (7) are embodied as cylindrical such that they have a respective longitudinal axis (13), in that the nozzle outlets (12) are arranged at one of the axial ends of the respective spray nozzle (7), and in that the at least one air inlet opening (10) in each case is arranged at the other axial end of the respective spray nozzle (7).

3. The method as claimed in claim 2,
characterized in that
referred to one of the spray nozzles (7) in each case, one of the oil inlet openings (9) is arranged at a defined axial position (z), viewed in the direction of the longitudinal axis (13), and at least one other of the oil inlet openings (9) is arranged at the same axial position (z), viewed in the direction of the longitudinal axis (13).

4. The method as claimed in claim 3,
characterized in that
the oil inlet openings (9) arranged at the defined axial position (z) are arranged evenly distributed, viewed around the longitudinal axis (13).

5. The method as claimed in one of the above claims,
characterized in that
the lubricating oil (5) is fed to the respective mixing chamber (8) in a flow-controlled manner.

6. The method as claimed in one of the above claims,
characterized in that
the compressed air (11) fed to the respective mixing chamber (8) has a pressure (p) that lies between 0.1 bar and 10 bar, in particular between 1.0 bar and 6.0 bar.

7. The method as claimed in one of the above claims,
characterized in that
a pressure (p) at which the compressed air (11) is fed to the respective mixing chamber (8) is set as a function of the quantity of lubricating oil (5) fed to the respective mixing chamber (8).

8. The method as claimed in claim 7,
characterized in that
the pressure (p) at which the compressed air (11) is fed to the respective mixing chamber (8) increases in line with the quantity of lubricating oil fed to the respective mixing chamber (8).

9. The method as claimed in one of the above claims,
characterized in that
the at least one air inlet opening (10) has a diameter (d1) that lies between 0.01 mm and 5 mm, preferably between 3 mm and 5 mm, in particular around at least 4 mm.

10. The method as claimed in one of the above claims,
characterized in that
the oil inlet openings (9) have a diameter (d2) that lies between 0.1 mm and 1.0 mm, in particular between 0.4 mm and 0.6 mm.

11. The method as claimed in one of the above claims,
characterized in that
the nozzle outlets (12) are in each case embodied as slit-shaped.

12. The method as claimed in one of the above claims,
characterized in that
the nozzle outlets (12) are spaced apart from the rolling stock (1) and/or the at least one roll (3, 4) onto which the lubricating oil (5) is sprayed at a distance (a1) that lies between 100 mm and 400 mm, in particular between 150 mm and 300 mm.

13. The method as claimed in one of the above claims,
characterized in that
the spray nozzles (7) are spaced apart from one another by a distance (a2) that lies between 50 mm and 300 mm, in particular between 100 mm and 200 mm.

14. The method as claimed in one of the above claims,
characterized in that
the lubricating oil (5) sprayed onto the rolling stock (1) and/or the at least one roll (3, 4) by one of the spray nozzles (7) in each case is sprayed onto a respective subarea (16) of the rolling stock (1) and/or of the at least one roll (3, 4), and in that the subareas (16) assigned to immediately adjacent spray nozzles (7) have a degree of overlap that lies between 0% and 50%.

15. A device for applying a lubricating oil (5) to flat metal rolling stock (1) and/or at least one roll (3, 4) of a roll stand (2) during the rolling of the rolling stock (1) in the roll stand (2),
wherein the device has a spray bar (6) which extends parallel to an axis of rotation (3′) of the at least one roll (3, 4) of the roll stand (2) and on which a plurality of spray nozzles (7) are arranged adjacent to one another,
wherein each of the spray nozzles (7) has a mixing chamber (8) to which a respective quantity of lubricating oil (5) is fed via a plurality of oil inlet openings (9) in each case,
wherein the respective mixing chamber (8) has in each case at least one air inlet opening (10) via which compressed air (11) is fed to the respective mixing chamber (8),
wherein each of the spray nozzles (7) has at least one nozzle outlet (12) via which the lubricating oil (5) atomized in the respective mixing chamber (8) to form an aerosol is sprayed onto the rolling stock (1) and/or the at least one roll (3, 4) of the roll stand (2).

16. The device as claimed in claim 15,
characterized in that
the spray nozzles (7) are embodied as cylindrical such that they have a respective longitudinal axis (13), in that the nozzle outlets (12) are arranged at one of the axial ends of the respective spray nozzle (7), and in that the at least one air inlet opening (10) in each case is arranged at the other axial end of the respective spray nozzle (7).

17. The device as claimed in claim 16,
characterized in that
referred to one of the spray nozzles (7) in each case, one of the oil inlet openings (9) is arranged at a defined axial position (z), viewed in the direction of the longitudinal axis (13), and at least one other of the oil inlet openings (9) is arranged at the same axial position (z), viewed in the direction of the longitudinal axis (13).

18. The device as claimed in claim 17,
characterized in that
the oil inlet openings (9) arranged at the defined axial position (z) are arranged uniformly distributed, viewed around the longitudinal axis (13).

19. The device as claimed in one of claims 15 to 18,
characterized in that
the at least one air inlet opening (10) has a diameter (d1) that lies between 0.01 mm and 5 mm, preferably between 3 mm and 5 mm, in particular around at least 4 mm.

20. The device as claimed in one of claims 15 to 19,
characterized in that
the oil inlet openings (9) have a diameter (d2) that lies between 0.1 mm and 1.0 mm, in particular between 0.4 mm and 0.6 mm.

21. The device as claimed in one of claims 15 to 20,
characterized in that
the nozzle outlets (12) are in each case embodied as slit-shaped.

22. The device as claimed in one of claims 15 to 21,
characterized in that
the nozzle outlets (12) are spaced apart from the rolling stock (1) and/or the at least one roll (3, 4) onto which the lubricating oil (5) is sprayed at a distance (a1) that lies between 100 mm and 400 mm, in particular between 150 mm and 300 mm.

23. The device as claimed in one of claims 15 to 22,
characterized in that
the spray nozzles (7) are spaced apart from one another by a distance (a2) that lies between 50 mm and 300 mm, in particular between 100 mm and 200 mm.

24. The device as claimed in one of claims 15 to 23,
characterized in that
the lubricating oil (5) sprayed onto the rolling stock (1) and/or the at least one roll (3, 4) by one of the spray nozzles (7) in each case is sprayed onto a respective subarea (16) of the rolling stock (1) and/or the at least one roll (3, 4) and in that the subareas (16) assigned to immediately adjacent spray nozzles (7) have a degree of overlap that lies between 0% and 50%.
